(19) United States
(12) Patent Application Publication
(10) Pub. No.: US 2019/0061049 A1
(43) Pub. Date: Feb. 28, 2019

(54) MACHINE LEARNING DEVICE, MACHINE LEARNING SYSTEM, AND MACHINE LEARNING METHOD

(71) Applicant: FANUC CORPORATION, Yamanashi (JP)

(72) Inventor: Yoshitaka KUBO, Yamanashi (JP)

(21) Appl. No.: 16/101,996

(22) Filed: Aug. 13, 2018

(30) Foreign Application Priority Data
Aug. 28, 2017 (JP) 2017-163734

(51) Int. Cl. B23K 26/03; G06F 15/18; G06N 3/08; G06T 7/00

(52) U.S. Cl. CPC B23K 26/032; G06T 7/0004; G06N 3/084; G06F 15/18

(57) ABSTRACT

The quality of optical components is judged by taking the use of the optical components into consideration. A machine learning device includes: a state observing means that acquires image data obtained by imaging an optical component and data related to the use of the optical component as input data; a label acquisition means that acquires an evaluation value related to judgment of the quality of the optical component as a label; and a learning means that performs supervised learning using a pair of the input data acquired by the state observing means and the label acquired by the label acquisition means as training data to construct a learning model for judging the quality of the optical component.

This application is based on and claims the benefit of priority from Japanese Patent Application No. 2017-163734, filed on 28 Aug. 2017, the content of which is incorporated herein by reference.

### BACKGROUND OF THE INVENTION

### Field of the Invention

The present invention relates to a machine learning device, a machine learning system, and a machine learning method for performing machine learning on optical components.

### Related Art

Optical components used in industrial laser machines are contaminated with dirt or are deteriorated with aging. The absorptivity of a laser beam changes due to the dirt or deterioration and a desired performance is not obtained.

Therefore, it is necessary to clean optical components periodically (for example, everyday when the optical component is a focusing lens) to recover the performance of the optical component. Moreover, since the performance is not recovered even if cleaning is performed, the quality of the optical component is judged after the cleaning. When the optical component is judged to be defective, the optical component needs to be replaced.

Patent Document 1 discloses an example of a technique related to quality judgment of optical components. In the technique disclosed in Patent Document 1, a colored projection unit that projects a laser beam having passed through a lens is provided so that the shadow of dust adhering to the lens can be projected to the projection unit and can be visually perceived. In this way, the presence of dust adhering to the lens through which a laser beam passes can be easily visually perceived (for example, see [Abstract] and Paragraphs [0024] to [0026] of Specification of Patent Document 1).

Patent Document 1: Japanese Unexamined Patent Application, Publication No. 2008-52861

### SUMMARY OF THE INVENTION

In such an ordinary technique as disclosed in Patent Document 1, a user has to visually judge the quality whenever judgment is performed. Moreover, although optical components are used for various uses, the use of an optical component is not sufficiently taken into consideration in the visual judgment. For example, although optical components are used in the same laser machine, if the uses such as the characteristics of lasers incident on optical components, the characteristics of machining target works, or the required machining accuracy are different, different performances are required for the optical components. However, such a use is not sufficiently taken into consideration.

Therefore, an object of the present invention is to provide a machine learning device, a machine learning system, and a machine learning method for judging the quality of optical components by taking the use of optical components into consideration.

(1) A machine learning device (for example, a machine learning device 10 to be described later) of the present invention includes: a state observing means (for example, a state observation unit 11 to be described later) that acquires image data obtained by imaging an optical component (for example, a focusing lens 21 to be described later) and data related to the use of the optical component as input data; a label acquisition means (for example, a label acquisition unit 12 to be described later) that acquires an evaluation value related to judgment of the quality of the optical component as a label; and a learning means (for example, a learning unit 13 to be described later) that performs supervised learning using a pair of the input data acquired by the state observing means and the label acquired by the label acquisition means as training data to construct a learning model for judging the quality of the optical component.

(2) The machine learning device according to (1) may be configured such that the optical component is an optical component used in a device (for example, a laser machine 20 to be described later) associated with laser processing, and the data related to the use of the optical component includes information indicating the characteristics of a laser beam incident on the optical component in the device associated with the laser processing.

(3) The machine learning device according to (1) or (2) may be configured such that the optical component is an optical component used in a device (for example, a laser machine 20 to be described later) associated with laser processing, and the data related to the use of the optical component includes information indicating the characteristics of a radiation target radiated with a laser beam by the device associated with the laser processing.

(4) The machine learning device according to any one of (1) to (3) may be configured such that the optical component is an optical component used in a device (for example, a laser machine 20 to be described later) associated with laser processing, and the data related to the use of the optical component includes information indicating the characteristics required for laser processing performed by the device associated with the laser processing.

(5) The machine learning device according to any one of (1) to (4) may be configured such that the state observing means acquires the image data imaged during maintenance performed after the optical component starts being used.

(6) The machine learning device according to any one of (1) to (5) may be configured such that the evaluation value is determined on the basis of the judgment of a user who visually observes the optical component.

(7) The machine learning device according to any one of (1) to (6) may be configured such that the evaluation value is determined on the basis of the result of using the optical component.

(8) The machine learning device according to any one of (1) to (7) may be configured such that the learning model constructed by the learning means is a learning model that outputs a value of a probability indicating whether the optical component satisfies predetermined criteria when the image data of the optical component and the data related to the use of the optical component are used as the input data.

(9) A machine learning system (for example, a machine learning system 1 to be described later) of the present invention is a machine learning system including a plurality of machine learning devices according to any one of (1) to (8), and the learning means included in the plurality of machine learning devices shares the learning model, and the learning means included in the plurality of machine learning devices performs learning on the shared learning model.

(10) A machine learning method of the present invention is a machine learning method performed by a machine learning device (for example, a machine learning device 10 to be described later), including: a state observing step of acquiring image data obtained by imaging an optical component (for example, a focusing lens 21 to be described later) and data related to the use of the optical component as input data; a label acquisition step of acquiring an evaluation value related to judgment of the quality of the optical component as a label; and a learning step of performing supervised learning using a pair of the input data acquired in the state observing step and the label acquired in the label acquisition step as training data to construct a learning model for judging the quality of the optical component.

According to the present invention, it is possible to judge the quality of optical components by taking the use of optical components into consideration.

### BRIEF DESCRIPTION OF THE DRAWINGS

FIG. 1 is a functional block diagram illustrating an entire configuration of an embodiment of the present invention.

FIG. 2 is a vertical cross-sectional view schematically illustrating a configuration of a laser machine according to an embodiment of the present invention. FIG. 3A is a schematic plan view when a focusing lens (with no spatter adhering thereto) according to an embodiment of the present invention is seen in the same axial direction as a laser beam. FIG. 3B is a schematic plan view when a focusing lens (with spatters adhering thereto) according to an embodiment of the present invention is seen in the same axial direction as a laser beam. FIG. 4 is a functional block diagram illustrating a configuration of a machine learning device according to an embodiment of the present invention. FIG. 5 is a flowchart illustrating an operation when constructing a learning model according to an embodiment of the present invention. FIG. 6 is a flowchart illustrating an operation when using a learning model according to an embodiment of the present invention.

### DETAILED DESCRIPTION OF THE INVENTION

Hereinafter, an embodiment of the present invention will be described in detail with reference to the drawings.

### Entire Configuration of Embodiment

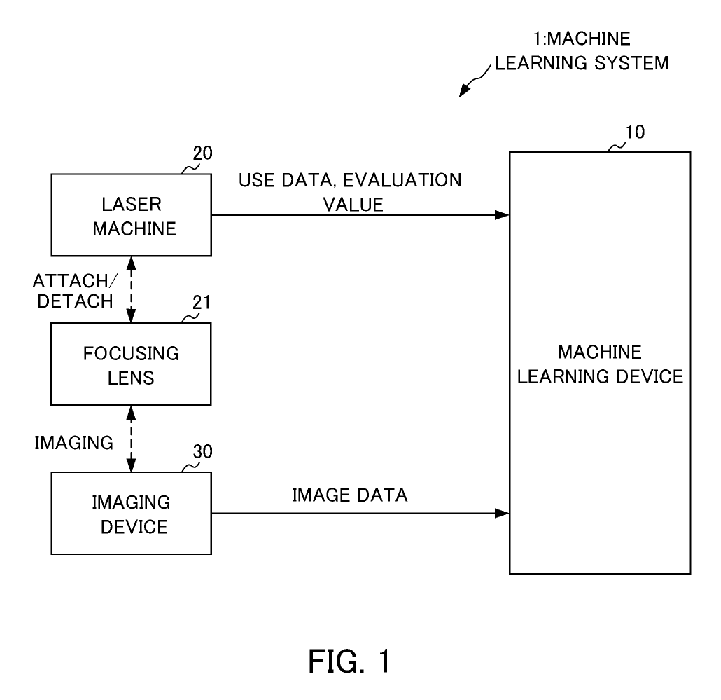

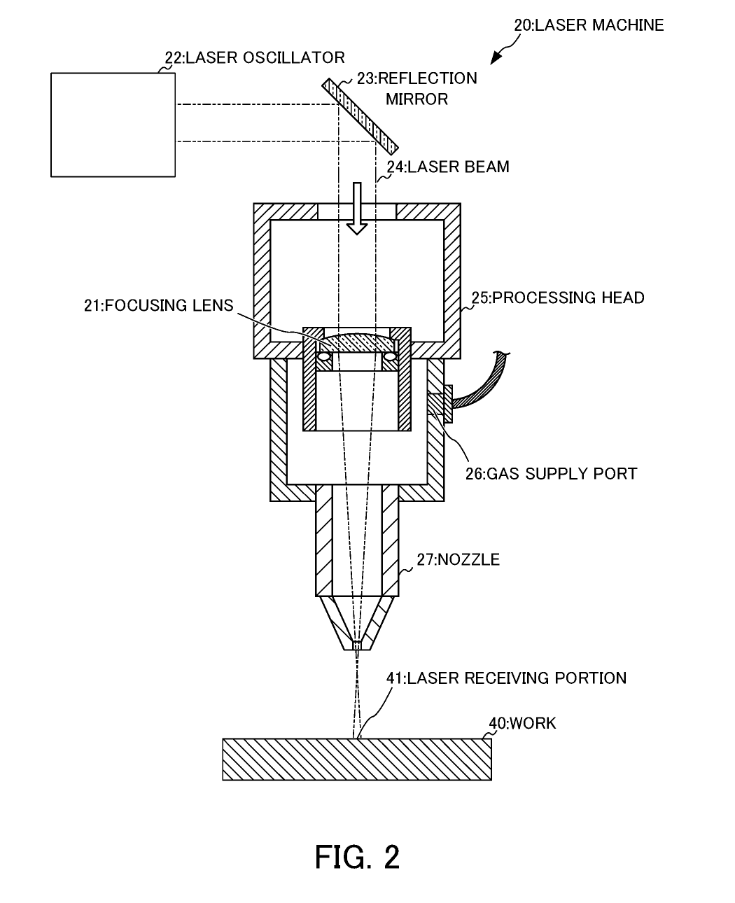

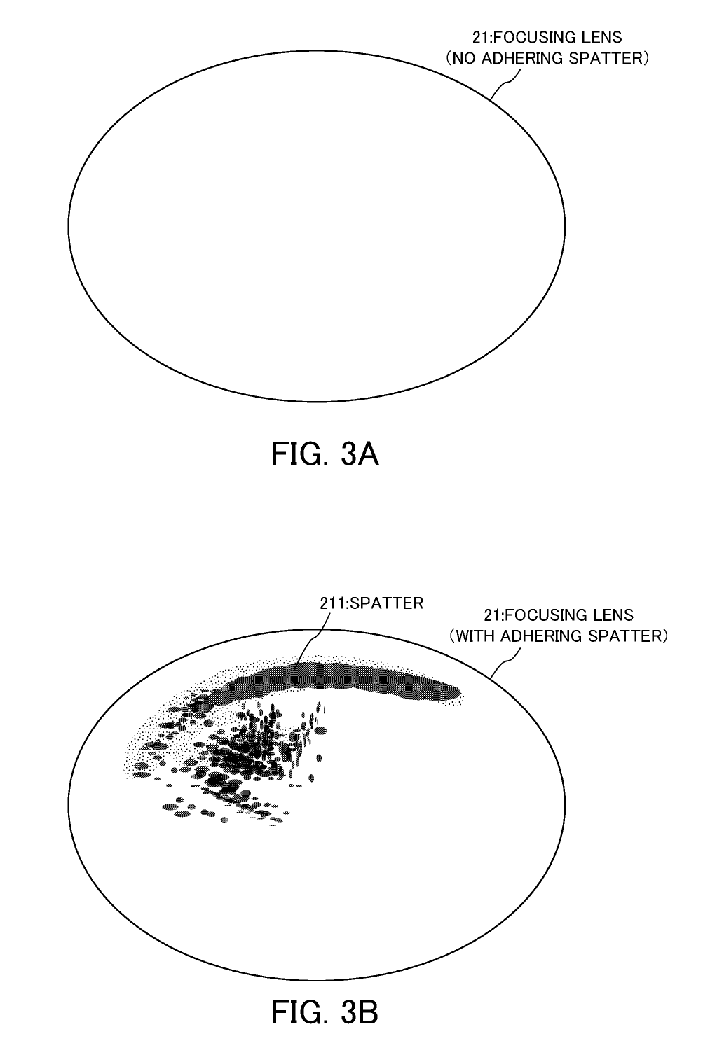

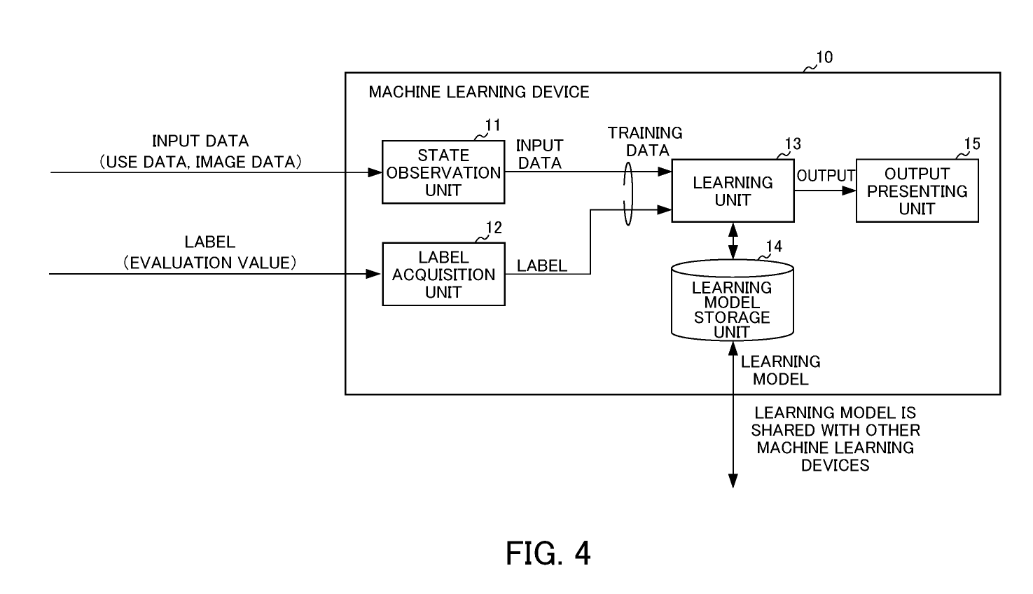

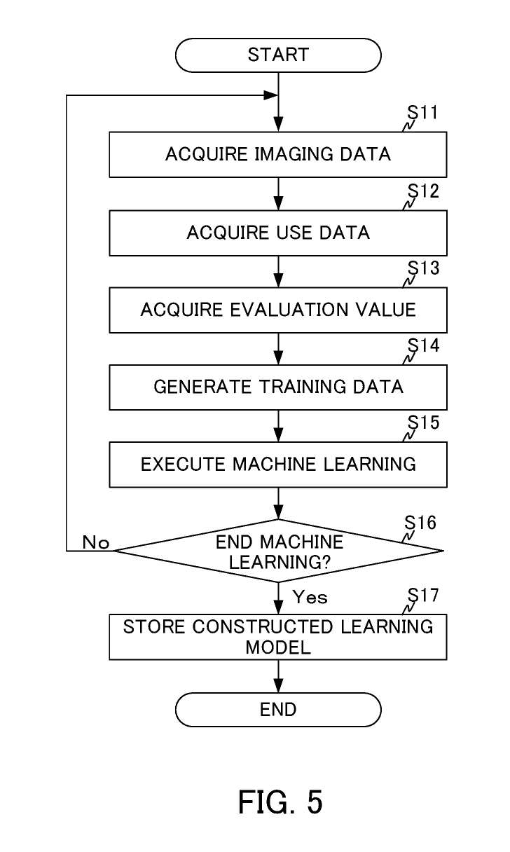

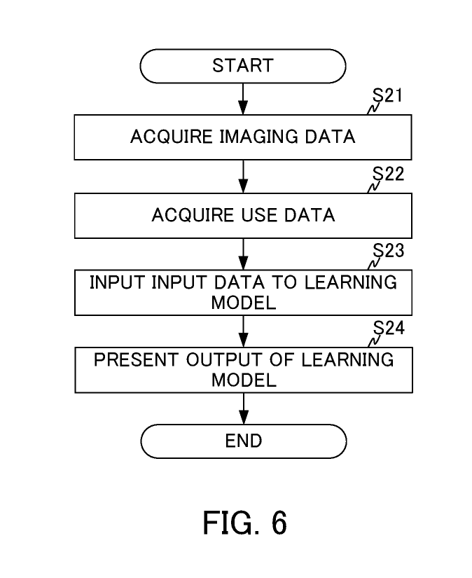

As illustrated in FIG. 1, a machine learning system 1 according to the present embodiment includes a machine learning device 10, a laser machine 20, and an imaging device 30. Moreover, the laser machine 20 includes a focusing lens 21 which is an optical component. In the drawing, a scene in which the focusing lens 21 is detached from the laser machine 20 and the focusing lens 21 is imaged by the imaging device 30 is illustrated, and the laser machine 20 and the focusing lens 21 are illustrated as separate members. However, in normal cases, the focusing lens 21 is used in a state of being attached to the inside of the laser machine 20 as will be described with reference to FIG. 2.

These respective devices included in the machine learning system 1 are communicably connected. This communication may be performed directly between respective devices and may be performed via a network including a relay device. The network is realized, for example, by a local area network (LAN) constructed in a factory or a virtual private network (VPN) constructed on the Internet.

The machine learning device 10 is a device that performs machine learning on the focusing lens 21 to construct a learning model for judging the quality of the focusing lens 21. The machine learning by the machine learning device 10 is performed by supervised learning using training data which uses image data obtained by imaging the focusing lens 21 and data related to the use of the focusing lens 21 as input data and an evaluation value related to the quality judgment of the focusing lens 21 as a label.

Here, the data related to the use of the focusing lens 21 includes, for example, data indicating the characteristics of a laser incident on the focusing lens 21 during laser processing performed by the laser machine 20, data indicating the characteristics of a target work radiated with a laser during laser processing, and data indicating the characteristics required for the laser processing. In the following description, the data related to the use of the focusing lens 21 will be referred to as “use data”.

In this manner, the machine learning device 10 performs supervised learning which uses the use data related to the use of the focusing lens 21 as well as the image data obtained by imaging the focusing lens 21 as part of the input data to construct a learning model. Due to this, the constructed learning model is a learning model capable of judging the quality of the optical component by taking the use of the optical component into consideration.

The laser machine 20 is a device for performing laser processing. Although it depends on the configuration of the laser machine 20, the laser machine 20 may perform laser processing by itself and the laser machine 20 may perform the laser processing in cooperation with an external device such as a controller or a host device controlling the laser machine 20. In the following description, it is assumed that the laser machine 20 includes an external device such as a controller and a host device unless particularly stated otherwise. As described above, the machine learning device 10 performs supervised learning with respect to the focusing lens 21 included in the laser machine 20. For this supervised learning, the laser machine 20 receives the input of use data and an evaluation value from a user. The laser machine 20 outputs the received use data and the evaluation value to the machine learning device 10. However, this configuration is an example only, and the machine learning device 10 may receive the use data and the evaluation value directly from the user rather than the laser machine 20 receiving the same and outputting the same to the machine learning device 10.

The imaging device 30 is a part that images the focusing lens 21 to perform supervised learning. The imaging device 30 outputs image data generated by imaging the focusing lens 21 to the machine learning device 10. The imaging device 30 is realized by an ordinary digital camera or a smartphone including a camera. Since a detailed configuration of the imaging device 30 is well known to those skilled in the art, a further detailed description thereof will be omitted.

<Configuration of Laser Machine 20>

Next, a configuration of the laser machine 20 including the focusing lens 21 on which the machine learning device 10 performs machine learning will be described with reference to FIG. 2. FIG. 2 is a vertical cross-sectional view illustrating a schematic configuration of the laser machine 20.

As illustrated in FIG. 2, the laser machine 20 includes the focusing lens 21, a laser oscillator 22, a reflection mirror 23, a laser beam 24, a processing head 25, a gas supply port 26, and a nozzle 27. In the drawing, a planar work 40 which is the target of machining of the laser machine 20 and a laser receiving portion 41 on the work 40 are also illustrated. Moreover, the laser oscillator 22 is illustrated as a functional block rather than a vertical cross-section.

On the other hand, components such as a movable table for installing the work 40 and a controller controlling the operation of the laser oscillator 22 and the processing head 25 are not illustrated because the components are not the subject matter of the present embodiment.

The laser oscillator 22 emits the laser beam 24 of which the cross-section is circular. The reflection mirror 23 reflects the laser beam 24 emitted from the laser oscillator 22 so as to be guided to the focusing lens 21 to thereby form a light guiding path that guides the laser beam 24 to the work 40.

The focusing lens 21 is used in a state of being fixed in the processing head 25. The focusing lens 21 focuses the laser beam 24 to radiate the laser beam 24 to the work 40 via the nozzle 27 attached to the distal end of the processing head 25. In this way, the laser receiving portion 41 of the work 40 is heated and melted by the laser beam 24 whereby laser processing is realized.

The type of the laser beam 24 used in the laser machine 20 is not particularly limited, and a carbon dioxide laser, a fiber laser, a direct diode laser, a YAG laser, and the like can be used.

As illustrated in FIG. 2, the processing head 25 has an approximately cylindrical shape so that the laser beam 24 is radiated to the work 40. Moreover, the processing head 25 has the gas supply port 26 formed in the processing head 25.

An assist gas is supplied from the gas supply port 26. The assist gas is exhausted along a gas passage extending from the gas supply port 26 to an opening at the distal end of the nozzle 27. Since the assist gas is supplied and exhausted into the inside of the main body of the nozzle 27 in this manner, the assist gas can be blown against the work 40 in the same axial direction as the laser beam 24 from the opening at the distal end of the nozzle 27.

In this way, the work 40 melted in the laser receiving portion 41 during laser radiation can be blown off from a groove formed on the laser receiving portion 41. Moreover, since the melted work 40 (spatters) scattering in the same axial direction as the laser beam 24 can be blown off, contamination of the focusing lens 21 can be prevented.

However, with such a configuration, it is not possible to blow off all spatters. Some spatters enter into the processing head 25 while resisting against the flow of the assist gas to adhere to the focusing lens 21.

Adhesion of spatters to the focusing lens 21 will be described with reference to FIGS. 3A and 3B. FIGS. 3A and 3B are schematic plan views when the focusing lens 21 is seen in the same axial direction as the laser beam 24.

FIG. 3A illustrates a state in which the focusing lens 21 is not used and no spatter adheres to the focusing lens 21. In this state, focusing of the focusing lens 21 can be performed appropriately and laser processing can be executed appropriately.

In contrast, FIG. 3B illustrates a state after the focusing lens 21 was used, and a state in which as described above, spatters entering into the processing head 25 while resisting against the flow of the assist gas adheres to the focusing lens 21. Thus, when spatters adheres to the focusing lens 21, focusing of the focusing lens 21 is not performed appropriately. For example, in a portion to which spatters adhere, the absorptivity of a laser beam increases and heat is generated. Due to this heat, a thermal lens effect occurs in the focusing lens 21 and the focal position thereof is shifted. Specifically, a portion of the focusing lens 21 swells mechanically and the focal position thereof is shifted. Moreover, the focal position is shifted further due to a change in the refractive index resulting from a temperature gradient of the focusing lens. Thus, when the focal position is shifted due to the thermal lens effect, it is not possible to execute laser processing in the laser receiving portion 41 appropriately. Moreover, when the focusing lens 21 is used continuously in a state in which spatters adhere thereto, the spatters are firmly fixed by heat and cannot be removed from the focusing lens 21 easily.

Therefore, it is necessary to perform cleaning of the focusing lens 21 periodically as part of maintenance. However, there are cases in which the spatters adhering to the focusing lens 21 can be removed completely by cleaning and cannot be removed completely.

In a case in which spatters cannot be removed completely, it is necessary to judge the quality of the focusing lens 21 in order to determine whether the focusing lens 21 after the cleaning is to be used again. However, as described in Related Art, the quality judgment was conventionally performed on the basis of user's rule of thumb and it was difficult to set a quantitative threshold. Moreover, conventionally, the use of the focusing lens 21 after cleaning has not been sufficiently taken into consideration.

Since the focusing lens 21 is expensive, although users generally use focusing lenses for different purposes according to the use thereof, it is difficult to judge the quality of focusing lenses when different purposes depending on use are taken into consideration. For example, when the purpose of the focusing lens is “to cut a surface clearly”, “to cut faster”, or “to cut a thick plate (generally 12 mm or thicker)”, a performance close to that of new products is required for the focusing lens 21.

Therefore, it was necessary to judge that the focusing lens 21 to which spatters adhere is “defective” and to replace the focusing lens 21 with a new focusing lens.

In contrast, when the purpose of the focusing lens is that “the quality required for a cutting surface is not too high”, “the cutting speed may be slow”, or “a thin plate (generally 3 mm or thinner) is cut”, a performance close to that of new products is not required for the focusing lens 21. Therefore, when a small amount of spatters adheres to the focusing lens 21 or when the position where spatters adhere is not a central portion (the portion where the laser beam 24 is incident) of the focusing lens 21, the focusing lens 21 may be judged to be “good” and may be used even after that. When different uses are taken into consideration, since the criterion for the quality judgment is also different depending on a use, the quality determination becomes more difficult.

Therefore, in the present embodiment, as described above, the machine learning device 10 performs supervised learning using the use data related to the use of the focusing lens 21 and the image data as input data to construct a learning model.

<Functional Blocks of Machine Learning Device 10>

Next, the functional blocks of the machine learning device 10 for construction of such a learning model will be described. The machine learning device 10 includes a state observation unit 11, a label acquisition unit 12, a learning unit 13, a learning model storage unit 14, and an output presenting unit 15.

The state observation unit 11 is a part that acquires the use data and the image data from the laser machine 20 and the imaging device 30, respectively, as input data and outputs the acquired input data to the learning unit 13. Here, the input data in the present embodiment includes the use data acquired from the laser machine 20 and the image data acquired from the imaging device 30 as described above. These pieces of data will be described in detail.

The use data includes, for example, any one or all of the data indicating the characteristics of a laser incident on the focusing lens 21 during laser processing, the data indicating the characteristics of a target work radiated with a laser during laser processing, and the data indicating the characteristics required for laser processing.

The data indicating the laser characteristics includes a laser output, a laser output command, and a work cutting speed, for example. The laser output is a rated output of the laser oscillator 22 of the laser machine 20. For example, the laser output is a value represented by a laser output “kW”. For example, when a carbon oxide laser is used for laser cutting, the laser output has values of 1 [kW], 2 [kW], . . . , and 6 [kW]. Since the heat generated by the focusing lens 21 is proportional to the intensity of a radiated laser beam, an optical component used in the laser oscillator 22 having a low output generally tends to have a long service life.

The laser output command is a command that the laser machine 20 receives in order to perform laser cutting. For example, the laser output command is a value represented by a peak power [W], a pulse frequency [Hz], and a pulse duty [%]. The work cutting speed is a cutting speed when the laser machine 20 performs laser cutting. For example, the work cutting speed is a value represented by a cutting speed [mm/minute].

The data indicating the characteristics of a target work radiated with a laser during laser cutting is a work material and a work thickness, for example. The work material is information for specifying the material of a work and is represented by an identifier for identifying the material such as mild steel, stainless steel, and aluminum. The work thickness is information for specifying the thickness of a planar work and is a value represented by a thickness [mm], for example.

The data indicating the characteristics required for laser cutting is information on the degree of difficulty of laser cutting, for example. The information on the degree of difficulty of laser cutting is a cutting margin, for example. The cutting margin can be represented by a focal amplitude. In order to specify the focal amplitude, the distance from the focusing lens 21 to a work is changed in units of 1 mm to examine a range in which a work can be cut satisfactorily. In this case, conditions (for example, the laser output, the cutting speed, and the like) other than the distance from the focusing lens 21 to the work is not changed. According to the examination, when the amplitude at which a work can be cut satisfactorily is 2 mm or smaller, for example, a cutting margin is small and the degree of difficulty is high. On the other hand, when the amplitude at which a work can be cut satisfactorily exceeds 3 mm, for example, a cutting margin is large and the degree of difficulty is low. Moreover, when the amplitude at which a work can be cut satisfactorily exceeds 2 mm and is 3 mm or smaller, for example, the cutting margin is normal and the degree of difficulty is normal. The data indicating the degree of difficulty specified in this manner can be used as the data indicating the characteristics required for laser cutting. The reference value such as 2 mm and 3 mm used as a reference for specifying the cutting margin is an example only and can be changed to an arbitrary value depending on an environment to which the present embodiment is applied. Moreover, the degree of difficulty may be set more minutely in a stepwise manner.

In addition to this, the data indicating the content of laser cutting requested by a user can be used as the data indicating the characteristics required for the laser cutting. For example, the request that a cutting surface is to be cut clearly or at a high speed, or the required quality of the cutting surface is not too high or the cutting speed may be slow can be used as the data indicating the characteristics required for the laser cutting.

A user inputs these various pieces of data to the laser machine 20 or the machine learning device 10, for example, as the use data. The state observation unit 11 acquires the input use data.

Next, the image data will be described. As described above, the image data is generated by the imaging device 30 imaging the focusing lens 21. The user detaches the focusing lens 21 from the laser machine 20 in order to perform maintenance of the focusing lens 21 at the site of a factory where the laser machine 20 is installed. In this case, the user images the detached focusing lens 21 using the imaging device 30 in order to generate image data. A user who performs a maintenance operation, for example, may perform the imaging at the state where maintenance is performed. Moreover, since the focusing lens 21 is detached as described above, the focusing lens 21 may be carried to an environment where imaging can be performed more easily than the site where maintenance is performed and then imaging may be performed. The state observation unit 11 acquires the image data generated by imaging from the imaging device 30.

The label acquisition unit 12 is a part that acquires the evaluation value from the laser machine 20 as a label and outputs the acquired label to the learning unit 13. Here, the evaluation value in the present embodiment is an evaluation value related to quality judgment and is a value indicating whether the focusing lens 21 can be used as it is (that is, “good”) or the focusing lens 21 needs to be replaced (that is, “defective”).

The evaluation value is determined on the basis of the judgment of a user who observes the focusing lens 21 detached from the laser machine 20. The user inputs the determined evaluation value to the laser machine 20 or the machine learning device 10, for example. The label acquisition unit 12 acquires the input evaluation value. Since it is desirable that the evaluation value is accurate, it is desirable that an expert operator makes judgment for determining the evaluation value.

The learning unit 13 receives a pair of the input data and the label as training data and performs supervised learning using the training data to construct a learning model. For example, the learning unit 13 performs supervised learning using a neural network. In this case, the learning unit 13 performs forward propagation in which the pair of the input data and the label included in the training data is input to a neural network formed by combining perceptrons and the weighting factors for the respective perceptrons included in the neural network are changed so that the output of the neural network is the same as the label.

In the present embodiment, the output of the neural network is classified into two classes of “good” and “defective”, and a probability that the output is classified to a certain class is output. Forward propagation is performed such that the value of a probability of the quality of the focusing lens 21 output by the neural network (for example, a value of the probability of 90% that the quality is “good”) is the same as the evaluation value of the label (for example, when the label indicates “good” in the quality, the value of the probability of “good” output by the neural network is 100%).

The learning unit 13 adjusts weighting factors so as to decrease the errors in the output of respective parameters by backpropagation (also referred to as an error back propagation) after performing forward propagation in this manner. More specifically, the learning unit 13 calculates an error between the label and the output of the neural network and corrects the weighting factor so as to decrease the calculated error. In this manner, the learning unit 13 learns the characteristics of training data and obtains a learning model for estimating a result from an input recursively.

In the present embodiment, the image data generated by the imaging device 30 imaging the focusing lens 21 is included in the input data. Therefore, the learning unit 13 may learn the characteristics of the image data using a convolutional neural network (CNN) which is a neural network suitable for learning the image data. Moreover, a learning model may be constructed using a neural network which receives both the characteristics of the use data learned by a neural network different from the convolutional neural network and the characteristics of the image data learned by the convolutional neural network. Alternatively, the learning model may be constructed using a neural network which receives both the use data itself and the characteristics of the image data learned by the convolutional neural network.

The learning unit 13 constructs a learning model by performing machine learning in the above-described manner. The learning model constructed by the learning unit 13 is output to the learning model storage unit 14.

The learning model storage unit 14 is a storage unit that stores the learning model constructed by the learning unit 13. When new training data is acquired after the learning model was constructed, the supervised learning may be added to the learning model stored in the learning model storage unit 14 and supervised learning may be performed additionally so that the learning model already constructed is updated appropriately. Although this additional learning may be performed automatically, the learning may be performed on the basis of user's judgment. That is, when the user judges that the quality judgment based on the learning model is wrong, the user may determine the use data and the evaluation value according to the user's own criteria so that the quality judgment is more accurate to thereby generate training data and perform additional learning. By performing such additional learning, it is possible to construct a learning model according to the user's own judgment criteria.

The output presenting unit 15 is a part that presents the output of the learning unit 13. As described above, in the present embodiment, since the result of the quality judgment on the focusing lens 21 can be output by the learning model constructed by the learning unit 13, the output presenting unit 15 presents the content of the output of the learning unit 13 to the user. The presentation may be performed, for example, by displaying information on a liquid crystal display or the like or by printing information on a paper medium, and may be performed by outputting sound (for example, a warning sound may be output when the quality judgment result shows that the possibility of “defective” is high).

Hereinabove, the functional blocks included in the machine learning device 10 have been described. In order to realize these functional blocks, the machine learning device 10 includes an arithmetic processing device such as a central processing unit (CPU). Moreover, the machine learning device 10 includes an auxiliary storage device such as a hard disk drive (HDD) storing various control programs such as application software and an operating system (OS) and a main storage device such as a random access memory (RAM) for storing data which is temporarily necessary for an arithmetic processing device to execute programs.

In the machine learning device 10, the arithmetic processing device reads application software and an OS from the auxiliary storage device and performs an arithmetic process based on the application software and the OS while deploying the read application software and the OS on the main storage device. Various hardware components included in the respective devices are controlled on the basis of this arithmetic processing result. In this way, the functional blocks of the present embodiment are realized. That is, the present embodiment can be realized by cooperation of software and hardware.

As a specific example, the machine learning device 10 can be realized by incorporating application software for realizing the present embodiment into an ordinary personal computer or a server device. However, since the machine learning device 10 involves a large amount of arithmetic operations associated with supervised learning, the supervised learning may be processed at a high speed, for example, when a graphics processing unit (GPU) is mounted on a personal computer and the GPU is used for arithmetic processing associated with the supervised learning according to a technique called general-purpose computing on graphics processing units (GPGPU). Furthermore, in order to realize faster processing, a computer cluster may be constructed using a plurality of computers having such a GPU mounted thereon and parallel processing may be performed by a plurality of computers included in the computer cluster.

Next, an operation during supervised learning of the machine learning device 10 will be described with reference to the flowchart of FIG. 5. In step S11, the state observation unit 11 acquires image data obtained by imaging the focusing lens 21 from the imaging device 30. The state observation unit 11 outputs the acquired image data to the learning unit 13.

In step S12, the state observation unit 11 acquires use data corresponding to the image data acquired in step S11. The state observation unit 11 outputs the acquired use data to the learning unit 13.

In step S13, the label acquisition unit 12 acquires an evaluation value corresponding to the image data and the use data acquired by the state observation unit 11 in steps S11 and S12, respectively. The label acquisition unit 12 outputs the acquired evaluation value to the learning unit 13. For the sake of convenience, although steps S11 to S13 are described in that order, these three steps may be executed in a different order and may be executed in parallel.

In step S14, the learning unit 13 generates training data by paring the respective pieces of data input in steps S11, S12, and S13 with each other.

In step S15, the learning unit 13 performs machine learning on the basis of the training data created in step S14. This machine learning is supervised learning and a method thereof is the same as described in the description of the functional blocks of the learning unit 13.

In step S16, the learning unit 13 determines whether or not to end machine learning. This determination is performed on the basis of predetermined conditions. For example, learning ends when conditions that the value of an error between the label and the output of the neural network is equal to or smaller than a predetermined value or supervised learning has been repeated for a predetermined number of times are satisfied.

When the conditions for ending the machine learning are not satisfied, a determination result of No is obtained in step S16 and the process returns to step S11. The above-described processes are repeated for new input data and new labels. On the other hand, when the conditions for ending the machine learning are satisfied, a determination result of Yes is obtained in step S16 and the process proceeds to step S17.

In step S22, the learning unit 13 stores the learning model constructed by the learning in step S22 in the learning model storage unit 14. By the operations described above, the learning unit 13 performs supervised learning using the use data related to the use of the focusing lens 21 and the image data as input data to construct a learning model. In this way, it is possible to construct a learning model for performing quality judgment of the focusing lens 21 by taking the use of the focusing lens 21 into consideration.

The above-described operations may be performed as a process for constructing a learning model and may be performed when maintenance is performed as usual on the laser machine 20 in a factory or the like.

Although the supervised learning is performed by online learning, the supervised learning may be also performed by batch learning or mini-batch learning. Online learning is a learning method in which supervised learning is performed whenever training data is created. Moreover, batch learning is a learning method in which a plurality of pieces of training data are collected while training data corresponding to the repetition is created repeatedly, and supervised learning is performed using all pieces of collected training data. Furthermore, mini-batch learning is a learning method which is intermediate between online learning and batch learning and in which supervised learning is performed whenever a certain amount of training data is collected.

Next, an operation when quality judgment is performed using the learning model constructed in this manner will be described with reference to the flowchart of FIG. 6. In step S21, the state observation unit 11 acquires the image data obtained by imaging the focusing lens 21 from the imaging device 30. The state observation unit 11 outputs the acquired image data to the learning unit 13.

In step S22, the state observation unit 11 acquires use data corresponding to the image data acquired in step S11. The state observation unit 11 outputs the acquired use data to the learning unit 13. Similarly to steps S11 to S13, steps S21 and S22 may be executed in a different order and may be executed in parallel.

In step S23, the learning unit 13 inputs the respective pieces of data input in steps S21 and S22 to the learned learning model stored in the learning model storage unit 14 as input data. The learning unit 13 outputs the output of the learning model corresponding to this input to the output presenting unit 15. The output presenting unit 15 presents the output of the learning model input from the learning unit 13 to the user as the result of the quality judgment.

By the operations described above, the machine learning device 10 can judge the quality of optical components by taking the use of the optical components into consideration. Moreover, the user can determine whether it is necessary to replace the focusing lens 21 or the like by referring to the presented result of quality judgment. In this way, it is possible to automate quality judgment without requiring the user's judgment based on visual observation which was conventionally performed whenever judgment is performed. Moreover, it is possible to model the conventional obscure judgment criteria and to indicate the judgment results as numerical values.

<Cooperation of Hardware and Software>

Each of the devices included in the machine learning system can be realized by hardware, software, or a combination thereof. Moreover, the machine learning method performed by the cooperation of the respective devices included in the machine learning system can be realized by hardware, software, or a combination thereof. Here, being realized by software means being realized when a computer reads and executes a program.

The programs can be stored on any of various types of non-transitory computer readable media and be provided to a computer. The non-transitory computer readable media include various types of tangible storage media. Examples of the non-transitory computer readable media include a magnetic recording medium (for example a flexible disk, a magnetic tape, and a hard disk drive), a magneto-optical recording medium (for example a magneto-optical disk), a CD-ROM (Read Only Memory), a CD-R, a CD-R/W, a semiconductor memory (for example a mask ROM, a PROM (Programmable ROM), an EPROM (Erasable PROM), a flash ROM, and a RAM (Random Access Memory)). The programs may be provided to a computer by using any of various types of transitory computer readable media. Examples of the transitory computer readable media include electric signals, optical signals and electromagnetic waves. A transitory computer readable medium can provide programs to a computer through a wired communication path such as an electrical cable, optical fiber, or the like or a wireless communication path.

### Modification of Embodiment

Although the respective embodiments are preferred embodiments of the present invention, the scope of the present invention is not to be limited to the afore-mentioned respective embodiments, the respective embodiments may be combined with each other and various modifications may be made without departing from the gist of the present invention.

<Modification 1>

In the respective embodiments described above, although the functions included in each of the machine learning device 10, the laser machine 20, and the imaging device 30 are realized by separate devices, some or all of these functions may be realized by an integrated device.

Moreover, one machine learning device 10 may be connected to a plurality of laser machines 20 and a plurality of imaging devices 30. Moreover, one machine learning device 10 may perform learning on the basis of the training data acquired from a plurality of laser machines 20 and a plurality of imaging devices 30. Furthermore, in the above-described embodiments, although one machine learning device 10 is illustrated, a plurality of machine learning devices 10 may be present. That is, the relation between the machine learning device 10 and the laser machine 20 and the imaging device 30 may be one-to-one relation and may be one-to-multiple relation or multiple-to-multiple relation.

<Modification 2>

As described in Modification 1, when a plurality of machine learning devices 10 is present, a learning model stored in the learning model storage unit 14 of any one of the machine learning devices 10 may be shared between other machine learning devices 10. When the learning model is shared between a plurality of machine learning devices 10, since supervised learning can be performed by the respective machine learning devices 10 in a distributed manner, the efficiency of supervised learning can be improved.

<Modification 3>

In the above-described embodiments, although the machine learning device 10 performs machine learning with respect to the focusing lens 21 included in the laser machine 20, the optical component is not limited to the focusing lens 21. The machine learning device 10 may perform machine learning with respect to other optical components instead of the focusing lens 21.

For example, the machine learning device 10 may perform machine learning with respect to an inner mirror or an external mirror included in the laser machine 20. For example, machine learning may be performed with respect to the reflection mirror 23. In addition to this, the machine learning device 10 may perform machine learning with respect to an optical component (not illustrated) included in the laser oscillator 22. A user detaches an optical component other than the focusing lens 21 in order to clean the optical component periodically (for example, every several hundred to thousand hours). Therefore, the user may image the detached optical component using the imaging device 30.

When the target optical component of machine learning is an optical fiber, a microscope is connected to the imaging device 30. The user may image the end face of the optical fiber using the microscope.

<Modification 4>

In the above-described embodiments, although the evaluation value is determined by the judgment of a user who visually observes the focusing lens 21, the evaluation value may be determined on the basis of the result of using the focusing lens 21 actually. In this case, the user fixes the focusing lens 21 to the laser machine 20 again after imaging the focusing lens 21 using the imaging device 30. Moreover, the user performs laser processing actually using the laser machine 20. The user determines the evaluation value on the basis of the result of the laser processing performed actually. In this way, it is possible to determine the evaluation value more accurately.

In this case, the machine learning device 10 may determine the evaluation value automatically on the basis of an inspection result of a work cut by the laser cutting performed actually. Therefore, the machine learning device 10 is connected to an inspection device that inspects whether the criteria such as the quality of a cutting surface of the cut work are satisfied, for example. The machine learning device 10 receives an inspection result from the inspection device. The machine learning device 10 determines the evaluation value as “good” upon receiving an inspection result that the criteria such as the quality of a cutting surface of the cut work are satisfied. On the other hand, the machine learning device 10 determines the evaluation value as “defective” upon receiving an inspection result that the criteria such as the quality of a cutting surface of the cut work are not satisfied. In this way, it is possible to eliminate the time and effort of the user inputting the evaluation value.

<Modification 5>

In the above-described embodiments, although use data is generated on the basis of the input of the user, the laser machine 20 may generate the use data automatically, for example. As described above, the use data may include, for example, a laser output represented by a laser output [kW] and a laser output command represented by a peak power [W], a pulse frequency [Hz], and a pulse duty [%]. Since these parameters are set in the laser machine 20, the laser machine 20 generates the use data automatically on the basis of the setting. In this way, it is possible to eliminate the time and effort of the user inputting the use data.

### EXPLANATION OF REFERENCE NUMERALS

1: Machine learning system
10: Machine learning device
11: State observation unit
12: Label acquisition unit
13: Learning unit
14: Learning model storage unit
15: Output presenting unit
20: Laser machine
21: focusing lens
22: Laser oscillator
23: Reflection mirror
24: Laser beam
25: processing head
26: Gas supply port
27: Nozzle
30: Imaging device
40: Work
41: Laser receiving portion

What is claimed is:

1. A machine learning device comprising:
a state observing means that acquires image data obtained by imaging an optical component and data related to the use of the optical component as input data;
a label acquisition means that acquires an evaluation value related to judgment of the quality of the optical component as a label; and
a learning means that performs supervised learning using a pair of the input data acquired by the state observing means and the label acquired by the label acquisition means as training data to construct a learning model for judging the quality of the optical component.

2. The machine learning device according to claim 1, wherein
the optical component is an optical component used in a device associated with laser processing, and
the data related to the use of the optical component includes information indicating the characteristics of a laser beam incident on the optical component in the device associated with the laser processing.

3. The machine learning device according to claim 1, wherein
the optical component is an optical component used in a device associated with laser processing, and
the data related to the use of the optical component includes information indicating the characteristics of a radiation target radiated with a laser beam by the device associated with the laser processing.

4. The machine learning device according to claim 1, wherein
the optical component is an optical component used in a device associated with laser processing, and
the data related to the use of the optical component includes information indicating the characteristics required for laser processing performed by the device associated with the laser processing.

5. The machine learning device according to claim 1, wherein
the state observing means acquires the image data imaged during maintenance performed after the optical component starts being used.

6. The machine learning device according to claim 1, wherein
the evaluation value is determined on the basis of the judgment of a user who visually observes the optical component.

7. The machine learning device according to claim 1, wherein
the evaluation value is determined on the basis of the result of using the optical component.

8. The machine learning device according to claim 1, wherein
the learning model constructed by the learning means is a learning model that outputs a value of a probability indicating whether the optical component satisfies predetermined criteria when the image data of the optical component and the data related to the use of the optical component are used as the input data.

9. A machine learning system including a plurality of machine learning devices according to claim 1, wherein
the learning means included in the plurality of machine learning devices shares the learning model, and the learning means included in the plurality of machine learning devices performs learning on the shared learning model.

10. A machine learning method performed by a machine learning device, comprising:
a state observing step of acquiring image data obtained by imaging an optical component and data related to the use of the optical component as input data;
a label acquisition step of acquiring an evaluation value related to judgment of the quality of the optical component as a label; and
a learning step of performing supervised learning using a pair of the input data acquired in the state observing step and the label acquired in the label acquisition step as training data to construct a learning model for judging the quality of the optical component.
